(19) United States
(12) Patent Application Publication
(10) Pub. No.: US 2019/0168777 A1
(43) Pub. Date: Jun. 6, 2019

(54) DEPTH BASED ALERTS IN MULTI-DISPLAY SYSTEM

(71) Applicant: Pure Depth, Inc., Redwood City, CA (US)

(72) Inventor: Richard John LESTER, Auckland (NZ)

(21) Appl. No.: 16/195,931

(22) Filed: Nov. 20, 2018

Related U.S. Application Data
(60) Provisional application No. 62/589,590, filed on Nov. 22, 2017.

(51) Int. Cl. B60W 50/14; G02B 27/22; H04N 13/395; G06K 9/00; G08G 1/16

(52) U.S. Cl. CPC B60W 50/14; G02B 27/2278; G08G 1/166; G06K 9/00805; H04N 13/395

(57) ABSTRACT

A multi-layer display may include a first screen and a second screen arranged in a substantially parallel manner, with the first screen and the second screen including an array of pixels and the second screen overlapping the first screen, a light configured to provide light to the first screen and the second screen of the multi-layer display system, and a processing system comprising at least one processor and memory. The processing system may be configured to: receive data from at least one camera; based on the receive data from the at least one camera, display image on the first screen; determine if an object in the image satisfies a predetermined condition; and upon determining that the object in the image satisfies the predetermined condition, display on the second screen an alert at least partially overlapping the object in the image displayed on the first screen.

### CROSS REFERENCE TO RELATED APPLICATION

This patent application claims priority to and the benefit of U.S. Provisional Application No. 62/589,590, filed on Nov. 22, 2017, which is hereby incorporated by reference herein in its entirety.

### RELATED APPLICATIONS

The depth based alerts described herein may be used in any multi-display system (MLD), including but not limited to in any of the multi-display systems described in any of U.S. patent application Ser. Nos. 14/986,158; 14/855,822; 14/632,999; 15/338,777; 15/283,525; 15/283,621; 15/281,381; 15/409,711; 15/393,297; 15/378,466; 15/359,732; 15/391,903, all of which are hereby incorporated herein by reference in their entireties.

### FIELD OF THE INVENTION

The invention relates generally to multi-layer displays and, more particularly, to multi-layer displays and methods for displaying depth based alerts on vehicle dash systems including a multi-layer displays.

### BACKGROUND

Vehicles have long been equipped with alert systems. For example, some vehicles include an alert system in which a sensor detects an object and output a sound when the object is detected. However, outputting sound in response to detecting an object does not provide a driver with an indication of the position of the object. In these situations, the driver may need to exit the vehicle before knowing what action needs to be taken to avoid hitting the object.

Vehicles have also been equipped with rear view cameras providing the driver a view of the back of the vehicle. However, existing systems do not provide driver with alerts that draw the driver's attention to potential obstacles and provide the driver with an indication of where the obstacles are located.

### SUMMARY

Exemplary embodiments of this disclosure provide a multi-layer display (MLD) system that can display content on different display screens provided in a stacked arrangement. The displayed content may include depth based alerts to bring awareness to the driver of moving and/or static obstacles. Exemplary embodiments include displaying live video, from a camera disposed on the vehicle, on a back screen of the MLD and displaying alerts on a front screen of the screen (e.g., as a simplified shape representing the object), when an object included in the live video has reached a certain threshold distance to the vehicle.

According to one exemplary embodiment, an instrument panel comprises: a multi-layer display including a first screen and a second screen arranged in a substantially parallel manner, the first screen and the second screen including an array of pixels and the second screen overlapping the first screen; a light configured to provide light to the first screen and the second screen of the multi-layer display; and a processing system comprising at least one processor and memory. The processing system is configured to: receive data from at least one camera; based on the receive data from the at least one camera, display an image on the first screen; determine if an object in the image satisfies a predetermined condition; and upon determining that the object in the image satisfies the predetermined condition, display on the second screen an alert at least partially overlapping the object in the image displayed on the first screen.

In another exemplary embodiment, determining if the object in the image satisfies the predetermined condition includes determining that the object is in a predetermined portion of the image corresponding to path of a vehicle including the instrument panel.

In another exemplary embodiment, determining if the object in the image satisfies the predetermined condition includes determining that the object is within a threshold distance from a vehicle including the instrument panel.

In another exemplary embodiment, determining if the object in the image satisfies the predetermined condition includes determining that the object is within a path of a vehicle including the instrument panel and within a threshold distance from the vehicle.

In another exemplary embodiment, the processing system is further configured to: receive data from a range sensor; and determine, based on the received data from the range sensor, whether the object in the image is within a threshold distance from the range sensor, and wherein the predetermined condition is that the object in the image is within the threshold distance from the range sensor.

In another exemplary embodiment, the alert is a feature with a shape corresponding to a shape of the object in the image.

In another exemplary embodiment, the alert is displayed with a first color when the object is determined to be positioned within a first distance from a vehicle including the instrument panel, and is displayed with a second color when the object is determined to be positioned within a second distance from the vehicle that is smaller than the first distance.

According to one exemplary embodiment, a multi-layer display system comprises: a first display panel and second display panel arranged in a substantially parallel manner, the second display panel overlapping the first display panel; a backlight configured to provide light to the first display panel and the second display panel of the multi-layer display system; and a processing system comprising at least one processor and memory. The processing system configured to: receive image data from at least one camera; based on the received data from the at least one camera, display images on the first display panel; determine if an object in the images is within a moving path of a vehicle and/or is with a predetermined distance from the vehicle; and upon determining that the object is within the moving path of the vehicle and/or is with the predetermined distance from the vehicle, display, on the second display panel, an alert corresponding to the object in the images.

In another exemplary embodiment, the alert comprises a shape corresponding to a shape of the object in the images and the alert is displayed in an overlapping manner with the object in the images.

In another exemplary embodiment, at least a portion of the alert is displayed with a partial opacity.

In another exemplary embodiment, the alert is displayed with a first color when the object is determined to be positioned within a first distance from the vehicle and a second color when the object is determined to be positioned within a second distance from the vehicle that is smaller than the first distance.

In another exemplary embodiment, the object in the image and the alert have the same shape and size.

In another exemplary embodiment, the alert is displayed on the second display panel at predetermined intervals while the object is within the moving path of the vehicle and/or is with the predetermined distance from the vehicle.

In another exemplary embodiment, the images are displayed on the first display panel in response to processing system receiving a signal indicating that the vehicle is in a reverse driving mode.

According to one exemplary embodiment, a vehicle display system comprises: a sensor disposed on a vehicle; a camera configured to capture images of an area behind the vehicle; a multi-layer display including a back display panel and a front display panel arranged in a substantially parallel manner, each display panel including an array of pixels; a backlight configured to provide light to the front and back display panels; and a processing system comprising at least one processor and memory. The processing system is configured to: receive sensor data from the sensor; receive image data from the camera; in response receiving a signal indicating that the vehicle is in a reverse driving mode, display, on the back display panel, images based on the received image data; based on the received sensor data and/or the received image data, determine whether an object is present in an estimated path of the vehicle; and upon determining that the object is present in the estimated path of the vehicle and the object satisfying a predetermined condition, display an alert on the front display panel, the alert having a shape and size corresponding to the object.

In another exemplary embodiment, the object is included in the images displayed on the back display panel, and the alert is displayed with partial opacity on the front display panel and overlapping the object in the images.

In another exemplary embodiment, the predetermined condition is the object being within an predetermine distance from the vehicle, the alert is displayed with a first color when the object is determined to be positioned within a first distance from the vehicle, and the alert is displayed with a second color when the object is determined to be positioned within a second distance from the vehicle.

In another exemplary embodiment, the position of the object from the vehicle is determined based on the received sensor data.

According to one exemplary embodiment, a method for displaying content on a multi-layer display system including at least first display panel and second display panel arranged in a substantially parallel and overlapping manner, the method comprises: receiving image data from at least one camera disposed on a vehicle; based on the received data from the at least one camera, displaying images on the first display panel; determining if an object in the images is within a moving path of a vehicle and is with a predetermined distance from the vehicle; and upon determining that the object is within the moving path of the vehicle and is with the predetermined distance from the vehicle, displaying, on the second display panel, an alert corresponding to the object in the images.

In another exemplary embodiment, the alert is displayed with a first color when the object is determined to be positioned within a first distance from the vehicle and a second color when the object is determined to be positioned within a second distance from the vehicle that is smaller than the first distance.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

So that features of the present invention can be understood, a number of drawings are described below. It is to be noted, however, that the appended drawings illustrate only particular embodiments of the invention and are therefore not to be considered limiting of its scope, for the invention may encompass other equally effective embodiments.

FIG. 1 illustrates a multi-layer display system according to an embodiment of the present disclosure.

FIG. 2 illustrates a vehicle including a plurality of sensors for detecting moving obstacles and/or static obstacles, according to an embodiment of the present disclosure.

FIG. 3 illustrates a method for displaying depth based alerts on an MLD system for detected obstacles, according to an embodiment of the present disclosure.

FIG. 4 illustrates a display of an instrument panel including an MLD system according to an embodiment of the present disclosure.

FIGS. 5A and 5B illustrate displaying depth based alerts on an instrument panel including an MLD system according to an embodiment of the present disclosure.

FIGS. 6A and 6B illustrate content that is displayed on a front screen and a back screen according to an embodiment of the present disclosure.

FIGS. 7A-7C illustrate displaying depth based alerts on an instrument panel including an MLD system according to another embodiment of the present disclosure.

FIGS. 8A and 8B illustrate content that is displayed on a front screen and a back screen according to an embodiment of the present disclosure.

FIG. 9 illustrates an exemplary processing system upon which various embodiments of the present disclosure(s) may be implemented.

### DETAILED DESCRIPTION

Systems and methods for displaying the alerts, according to the embodiments disclosed in this application, allow for an occupant of a vehicle to receive depth based alerts that more effectively draw the occupant's attention to the potential danger. The depth based alerts do not only draw the attention of the driver to presence of an obstacle, but also provide an indication of where the obstacle is located. The alert draws better attention to the occupant because the alert is displayed on a display screen that is physically displaced from a screen displaying an image with the obstacle.

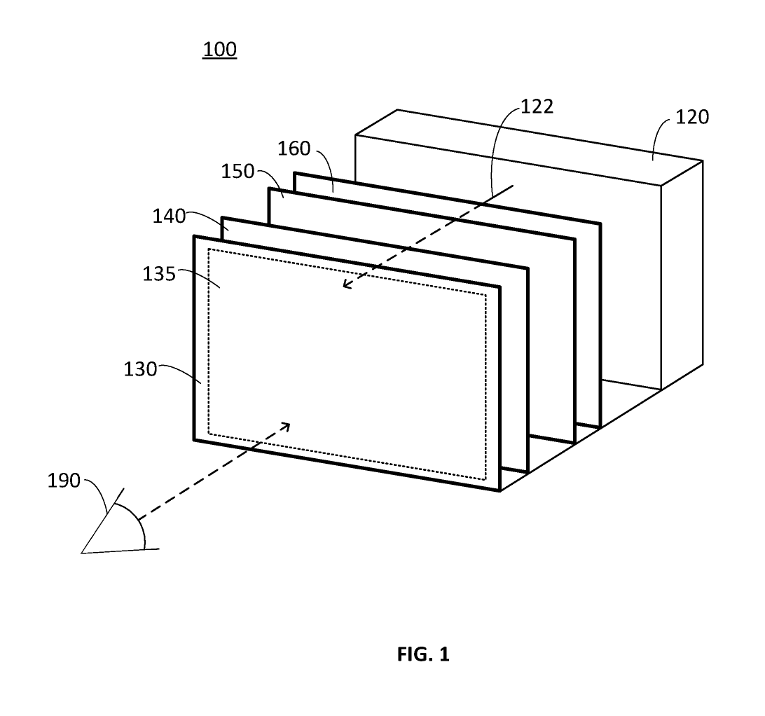

FIG. 1 illustrates a multi-layer display system 100 according to an embodiment of the present disclosure. The display system 100 may include a light source 120 (e.g., rear mounted light source, side mounted light source, optionally with a light guide), and a plurality of display screens 130-160. Each of the display screens 130-160e may include multi-domain liquid crystal display cells.

The display screens 130-160 may be disposed substantially parallel or parallel to each other and/or a surface (e.g., light guide) of the light source 120 in an overlapping manner In one embodiment, the light source 120 and the display screens 130-160 may be disposed in a common housing. The display apparatus 100 may be provided in an instrument panel installed in a dashboard of a vehicle. The instrument panel may be configured to display information to an occupant of the vehicle via one or more displays 130-160 and/or one or more mechanical indicators provided in the instrument panel. The displayed information may include vehicle speed, engine coolant temperature, oil pressure, fuel level, charge level, and navigation information, but is not so limited. It should be appreciated that the elements illustrated in the figures are not drawn to scale, and thus, may comprise different shapes, sizes, etc. in other embodiments.

The light source 120 may be configured to provide illumination for the display system 100. The light source 120 may provide substantially collimated light 122 that is transmitted through the display screens 130-160.

Optionally, the light source 120 may provide highly collimated light using high brightness LED's that provide for a near point source. The LED point sources may include pre-collimating optics providing a sharply defined and/or evenly illuminated reflection from their emission areas. The light source 120 may include reflective collimated surfaces such as parabolic mirrors and/or parabolic concentrators. In one embodiment, the light source 120 may include refractive surfaces such as convex lenses in front of the point source. However, the LEDs may be edge mounted and direct light through a light guide which in turn directs the light toward the display panels in certain example embodiments.

Each of the display panels/screens 130-160 may include a liquid crystal display (LCD) matrix, which a backplane that may be glass or polymer. Alternatively, the display screens 130-160 may include organic light emitting diode (OLED) displays, transparent light emitting diode (TOLED) displays, cathode ray tube (CRT) displays, field emission displays (FEDs), field sequential display or projection displays. In one embodiment, the display panels 130-160 may be combinations of either full color RGB, RGBW or monochrome panels. One or more of the display screens 130-160 may be in-plane switching mode liquid crystal display devices (IPS-LCDs). The IPS-LCD may be a crossed polarizer type with a polarizer on one side of the cells being perpendicular to a polarizer on an opposite side of the cells (i.e., transmission directions of the polarizers are placed at right angles). The display screens 130-160 are not limited to the listed display technologies and may include other display technologies that allows for the projection of light. In one embodiment, the light may be provided by a projection type system including a light source and one or more lenses and/or a transmissive or reflective LCD matrix. The display screens 130-160 may include a multi-layer display unit including multiple stacked or overlapped display layers each configured to render display elements thereon for viewing through the uppermost display layer.

In one embodiment, each of the display screens 130-160 may be approximately the same size and have a planar surface that is parallel or substantially parallel to one another. In another embodiment, one or more of the display screens 130-160 may have a curved surface. In one embodiment, one or more of the display screens 130-160 may be displaced from the other display screens such that a portion of the display screen is not overlapped and/or is not overlapping another display screen.

Each of the display screens 130-160 may be displaced an equal distance from each other in example embodiments. In another embodiment, the display screens 130-160 may be provided at different distances from each other. For example, a second display screen 140 may be displaced from the first display screen 130 a first distance, and a third display screen 150 may be displaced from the second display screen 140 a second distance that is greater than the first distance. The fourth display screen 160 may be displaced from the third display screen 150 a third distance that is equal to the first distance, equal to the second distance, or different from the first and second distances.

The display screens 130-160 may be configured to display graphical information for viewing by the observer 190. The viewer/observer 190 may be, for example, a human operator or passenger of a vehicle, or an electrical and/or mechanical optical reception device (e.g., a still image, a moving-image camera, etc.). Graphical information may include visual display of objects and/or texts with object and/or texts in one display screen overlapping objects and/or texts displayed on another display screen. In one embodiment, the graphical information may include displaying images or a sequence of images to provide video or animations. In one embodiment, displaying the graphical information may include moving objects and/or text across the screen or changing or providing animations to the objects and/or text. The animations may include changing the color, shape and/or size of the objects or text. In one embodiment, displayed objects and/or text may be moved between the display screens 130-160. The distances between the display screens 130-160 may be set to obtain a desired depth perception between features displayed on the display screens 130-160.

The display system 100 may be configured to provide depth based alerts to bring awareness to a driver. The depth based alerts may bring awareness to the driver of any moving or static obstacles in the path of a vehicle. The alert(s) may be displayed once predetermined conditions relating to the obstacle(s) (e.g., predetermined distance is reached between the vehicle and the obstacle) has been satisfied. An image of the obstacle may be displayed on one of the displays and an alert relating to the obstacle may be displayed on another display (e.g., an overlapping display).

In one embodiment, a position of one or more of the display screens 130-160 may be adjustable by an observer 190 in response to an input. Thus, an observer 190 may be able to adjust the three dimension depth of the displayed objects due to the displacement of the display screens 130-160. A processing system may be configured to adjust the displayed graphics and gradients associated with the graphics in accordance with the adjustment.

Each of the display screens 130-160 may be configured to receive data and display, based on the data, a different image on each of the display screens 130-160 simultaneously. Because the images are separated by a physical separation due to the separation of the display screens 130-160, each image is provided at a different focal plane and depth is perceived by the observer 190 in the displayed images. The images may include graphics in different portions of the respective display screen.

While not illustrated in FIG. 1, the display system 100 may include one or more projection screens, one or more diffraction elements, and/or one or more filters between an observer 190 and the projection screen 160, between any two display screens 130-160, and/or the display screen 130 and the light source 120.

The display system 100 may be used to display depth based alerts to an occupant of a vehicle. While the embodiments disclosed below will be discussed with reference to a car, the embodiments of this disclosure are not so limited, and may be applied to boats, planes, motorcycles, buses, or other types of vehicles including a display panel. The purpose of depth base alerts is to bring awareness to the driver of any moving or static obstacles in the path of the vehicle. Live video is rendered on the back screen of the MLD. The alerts are displayed on the front screen as a simplified shape representing the object. The alerts are only displayed once the object has reached a certain threshold distance to the vehicle.

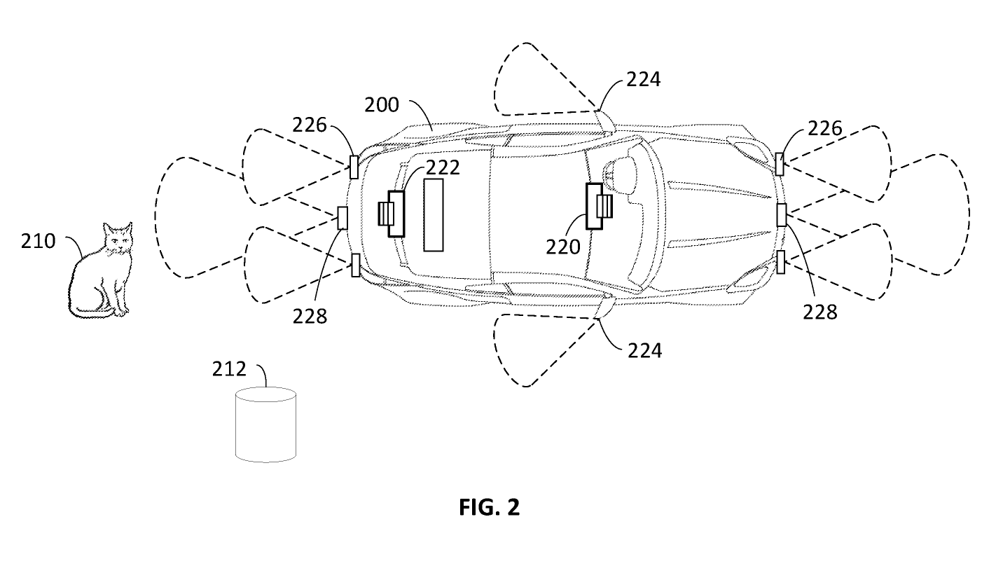

FIG. 2 illustrates a vehicle 200 including a plurality of sensors 220-228 for detecting moving obstacles 210 and/or static obstacles 212, according to an embodiment of the present disclosure. The vehicle 200 may include a plurality of sensors 220-228 configured capture data relating to the environmental conditions (e.g., presence of objects) around the vehicle. In some embodiments, information from one or more of the sensors can be received by a processing system and processed to detect moving obstacles 210 and/or static obstacles 212. In some embodiments, the data from one or more sensors may also be used simultaneously for controlling operation of the vehicle (e.g., from driver assistance driving to full automation).

The sensors may include image sensors, radar sensors, and/or LIDAR (Light Detection and Ranging) sensors. In FIG. 2, sensor 220 may be an image sensor, such as a camera, configured to capture images of the area in front of the vehicle 200. Sensor 222 may be an image sensor, such as a camera, configured to capture images of the area behind the vehicle 200. Sensors 222 may provide images that are used by a processing system to detect object. In some embodiments, a single camera system may capture a 360 degree view around the vehicle.

Sensors 224 may be short range sensors that capture information about the blind spots. Sensors 224 may include image sensors and/or radar sensors. The vehicle may also include short range sensors 226 positioned in front and/or behind the vehicle to detect obstacles in front and/or behind the vehicle. The vehicle may also include long range sensors 228 positioned in front and/or behind the vehicle to detect obstacles in front and/or behind the vehicle.

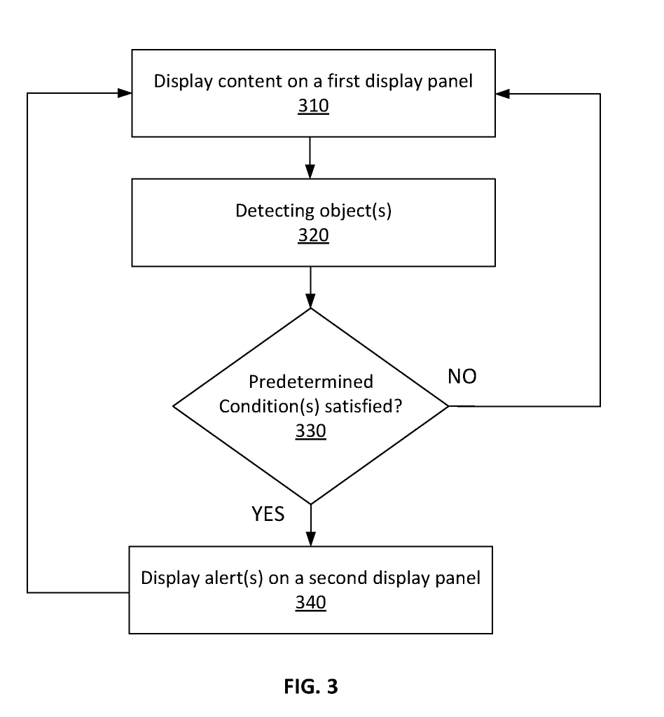

FIG. 3 illustrates a method for displaying depth based alerts on an MLD system for detected obstacles, according to an embodiment of the present disclosure. The method may be performed by a processing system including at least one processor and memory. The method provides a technique by which depth based alerts can bring vehicle occupants awareness of moving and/or static obstacles in the path of a vehicle. The method may include displaying content on a first display panel (Step 310), detecting object(s) (Step 320), determining if predetermined condition(s) are satisfied (Step 330), and displaying alert(s) on the second display panel (Step 340).

Displaying content on a first display panel (Step 310) may include displaying images captured by a sensor (e.g., a camera disposed on a vehicle). For example, a camera on a vehicle may capture images of an area in front and/or behind the vehicle. The captures images can be displayed in real-time on a display panel of an MLD that is overlapped by one or more other display panels.

The content may be displayed on a portion of the first display panel or the whole first display panel. In some embodiments, the content may be displayed on the first panel in response to an instruction from the processing system. The instruction to display the content on the first display panel may be issued in response to satisfying a predetermined condition, such as receiving a user input, vehicle being put in driving mode (e.g., forward or reverse drive), and/or one or more sensors detecting presence of an obstacle. The processing system may receive a signal when the vehicle is placed in a forward or reverse driving mode.

In one embodiment, a long range sensor may detect that there is an object that could be in the path of the vehicle and the processing system, based on data from the long range sensor, may initiate displaying the images captured by the camera on the first display before the object is detected by the system based on the images captured by the camera.

The detection of objects (Step 320) that may be in the path of the vehicle may be performed based on information from one or more sensors (e.g., see sensors 220-228 shown in FIG. 2). In one embodiment, images from one or more cameras may be analyzed to determine presence of an object. Whether an object is present may include determining whether the object is present in a predetermine portion of the captured image. The predetermined portion of the image in which the object is detected may correspond to an estimated path of the vehicle.

The predetermined portion of the image in which the object is detected may change based on operating conditions of the vehicle. For example, the turning direction of one or more wheels (e.g., front and/or back wheels) may determine in which portion of the image to detect the object. In another embodiment, the vehicle speed may change the portion of the captured image in which the object is detected. For example, if the vehicle slows down, the portion of the image used to detect the object may be reduced. If the vehicle speeds up, the portion of the image used to detect the object may be increased.

Analyzing the images to determine presence of an object, may include detecting a surface on which the vehicle is located and objects that are provided on the road surface. The surface may be treated as a background and objects on the background may be extracted as detected objects.

The method includes determining whether one or more predetermined conditions related to the detected object(s) are satisfied (Step 330). The predetermined condition may include that the detected object is in the path of the vehicle, that the detected objects is a certain threshold distance to the vehicle, and/or that the detected object is at least a predetermined size.

If the detected object does not satisfy one or more of the predetermined conditions or a specific number of the predetermined conditions (No in Step 330), then the method may repeat displaying content on the first display panel and detecting object operations. If the detected object satisfies one or more of the predetermined conditions or a specific number of the predetermined conditions (Yes in Step 330), then an alert may be displayed on a second display panel. The second display panel may be a panel that overlaps the first display panel. The second display panel may be a front panel of the MLD system. The alert may include a simplified shape representing the detected object, the detected object, text, symbol, and/or animation. The alert may be displayed such that it overlaps the content and/or the object simultaneously displayed on the first display panel.

The simplified shape may be generated by performing edge detection on the detected object and generating a shape that corresponds only to the outside edges of the detected object. In some embodiments, interior edges of the detected object may also be displayed as part of the alert to help the occupant perceive the dimensions of the detected object. The simplified shape may be displayed on the second display panel such that it overlaps the corresponding object simultaneously displayed on the first display panel. The first and second display panels may need to be calibrated by the manufacturer and/or the occupant to ensure that the simplified shape aligns with the object.

In some embodiments, the alert may include the object extracted from the image. The object may be extracted from the image by image segmentation and displayed on the second display panel. The opacity, size, and/or color of the extracted object may be modified before it is displayed on the second display panel.

The alert overlapping the object may be displayed such that the occupant of the vehicle can still, at least partially, see the detected object in the content displayed on the first display panel. For example, opacity, size, and/or color of the alert may be set such that the alert on the second display panel does not completely obscure the visibility of the detected object.

The opacity, size, and/or color of the alert may change based on the distance the object is from the vehicle. For example, the alert may be displayed in yellow color when the object is a first predetermined distance from the vehicle and in a red color when the object is a second predetermined distance from the vehicle which is smaller than the first predetermined distance. In some embodiments, the opacity and/or size of the object may increase as the objects gets closer to the vehicle.

In some embodiments, the alert may be displayed on both the first display panel and the second display panel. The alerts displayed on the different display panels may be the same alert or different alerts. For example, warning text or symbol may be displayed on the first display panel and a simplified shape representing the detected object may be displayed on the second display panel.

The alert may be continuously displayed on the second display panel while the detected object satisfies the predetermined condition(s). In some embodiments, the alert may be intermediately displayed at predetermined intervals on one or more display panels. The intervals may be decreased as the vehicle gets closer to the object.

The alert may transition between the first display panel and the second display panel. The transition of the alert may include the alert being displayed on one or more other display panels disposed between the first and second display panel during the transition. The speed of the transition may increase as the object gets closer to the vehicle.

In an alternative embodiment, an image of data captured by a camera may be displayed on a front display panel that overlaps one or more other display panels and, upon determining that an object is in the path of the vehicle, (1) move the image to one of the overlapped display panels and (2) display the alert on the front display panel. In this embodiment, the image and alert are displayed on the same display panel but the image captured by the camera is moved to another display panel when the alert is displayed.

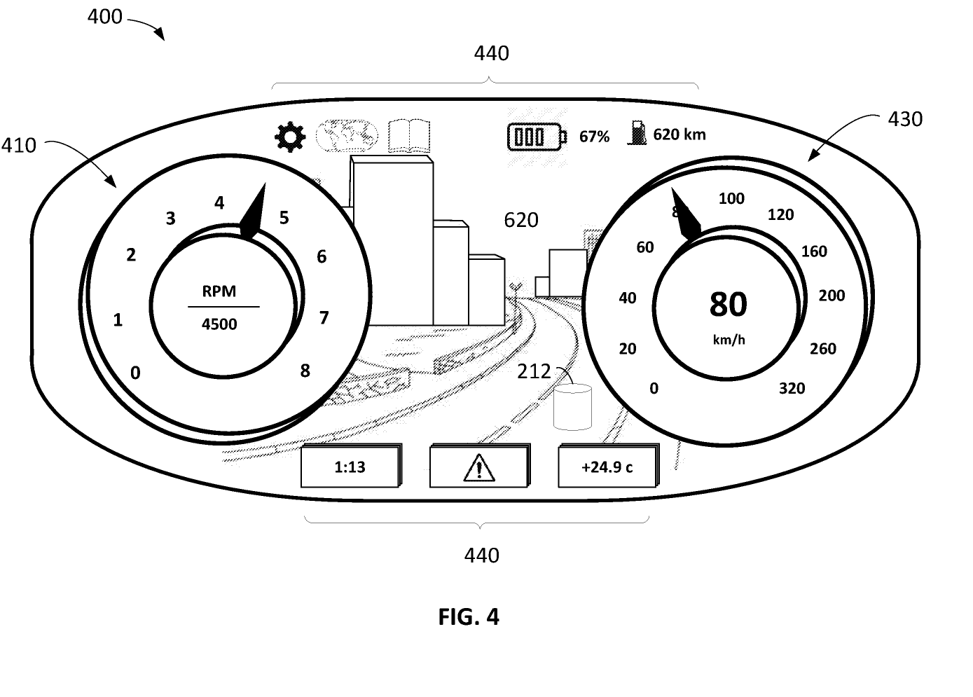

FIG. 4 illustrates a display of an instrument panel 400 including an MLD system according to an embodiment of the present disclosure. The instrument panel 400 may display content relating to captured image data on a first display panel and alerts on a second display panel. The alerts are related to content displayed on the first display panel.

The instrument panel 400 may display content simultaneously on different displays. The content may include a tachometer 410, image of data captured from sensors 420, a speedometer 430, and other information 440. The other information may include vehicle temperature, fuel level, distance left before refueling, contact list, navigation settings, control settings, and warning information.

Content of the instrument panel 400 may be displayed using a plurality of displays to provide a perception of depth. For example, the tachometer 410 and/or speedometer 430 may be displayed using three displays of an MLD system. The image of data captured from sensors 420 may be displayed on a display panel (a rear display panel) overlapped by other panels.

As shown in FIG. 4, the image of data captured from sensors 420 may include one or more objects 212 that are in the path of the vehicle. The display system may display an alert for the object. The alert may be displayed on a display panel that is different from the display panel on which the image of data captured from sensors 420 is displayed.

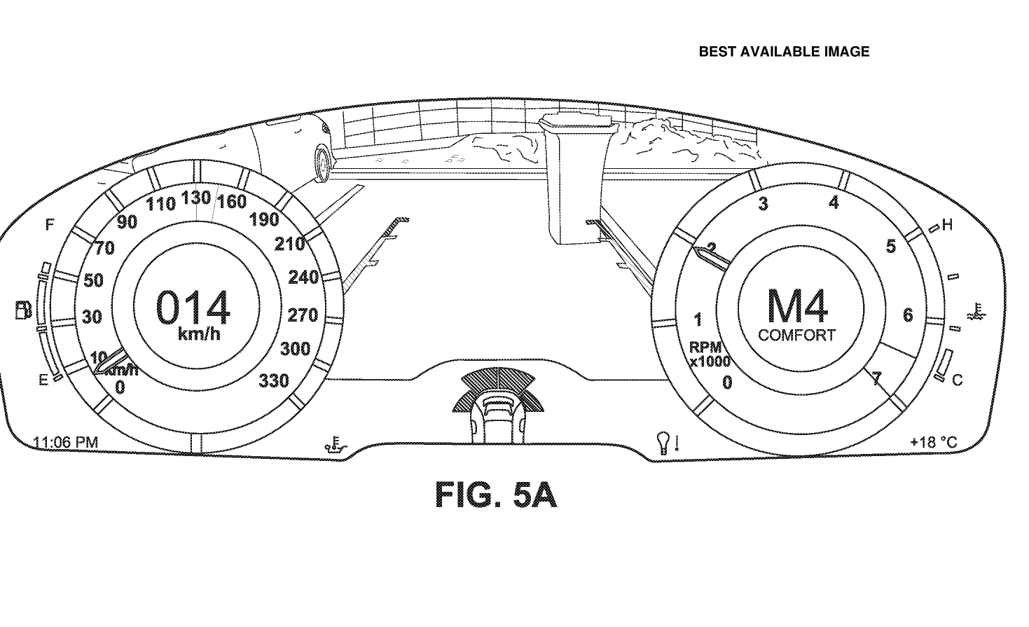

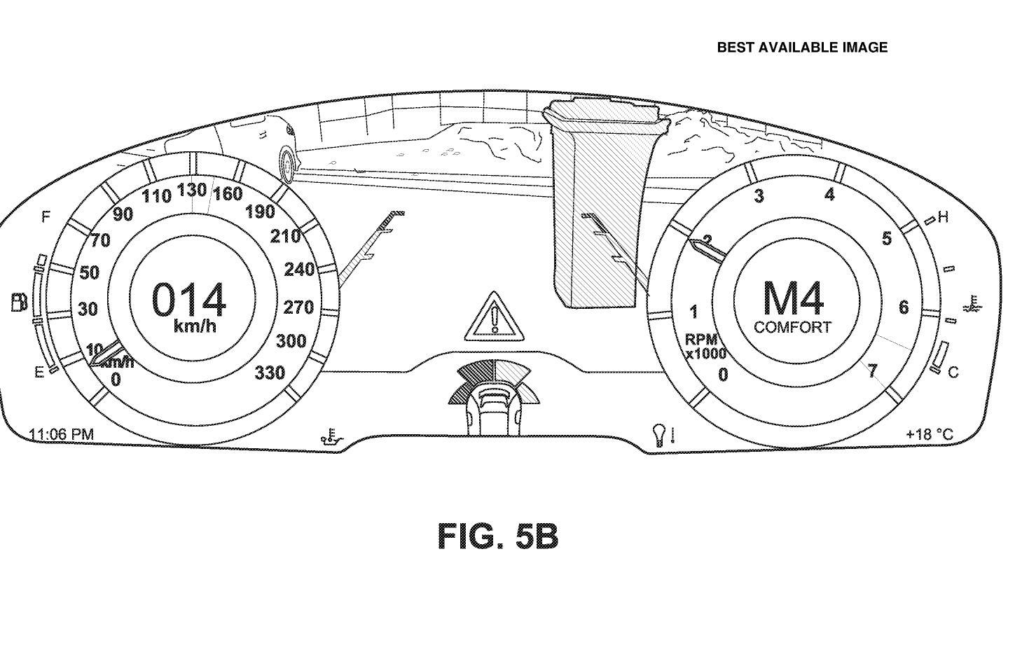

FIGS. 5A and 5B illustrate displaying depth based alerts on an instrument panel including an MLD system according to an embodiment of the present disclosure. In FIGS. 5A and 5B, the vehicle is in a reverse sequence. FIGS. 5A and 5B illustrates a tachometer, a speedometer, and various operating conditions of the vehicle. In the reverse sequence, an image of the space behind the vehicle is captured by a camera and displayed on a back screen of the MLD system. The MLD system may include indicators to show the predicted path of the vehicle. The indicators may be displayed overplayed over the image on the back screen or displayed on a screen that overlaps the back screen.

As the vehicle moves in the reverse direction, data from one or more sensors is analyzed and/or image analysis of the image data from the camera is performed to determine whether there is an object that is in a path of the vehicle and/or at a predetermined distance to the vehicle. As shown in FIG. 5A, a dustbin is in the path of the vehicle but is not within a predetermined distance at which an alert is displayed. In FIG. 5B, the dustbin is in the path of the vehicle and is within a predetermined distance at which an alert is displayed.

The alert includes displaying, on a front screen, a simplified shape representing the object. The simplified shape may be displayed with a red color to draw additional attention to the object. The alert may also include displaying a warning symbol (see bottom center of FIG. 5B). The MLD system may also display an indicator showing relative direction of the object to the vehicle based on vehicle's sensors. The sensors corresponding to the direction of the object may be displayed with a different color (e.g., red) from other sensors.

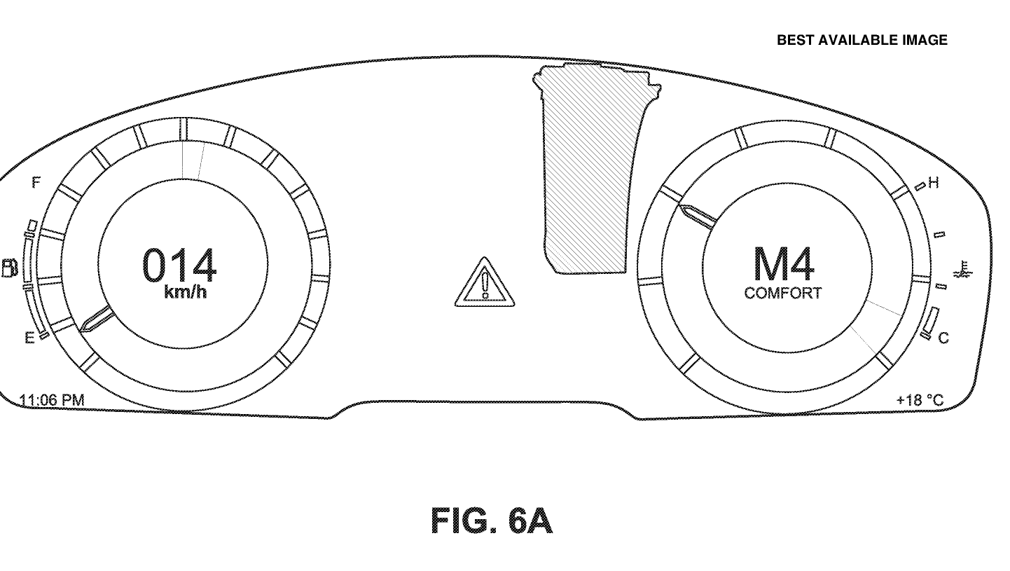

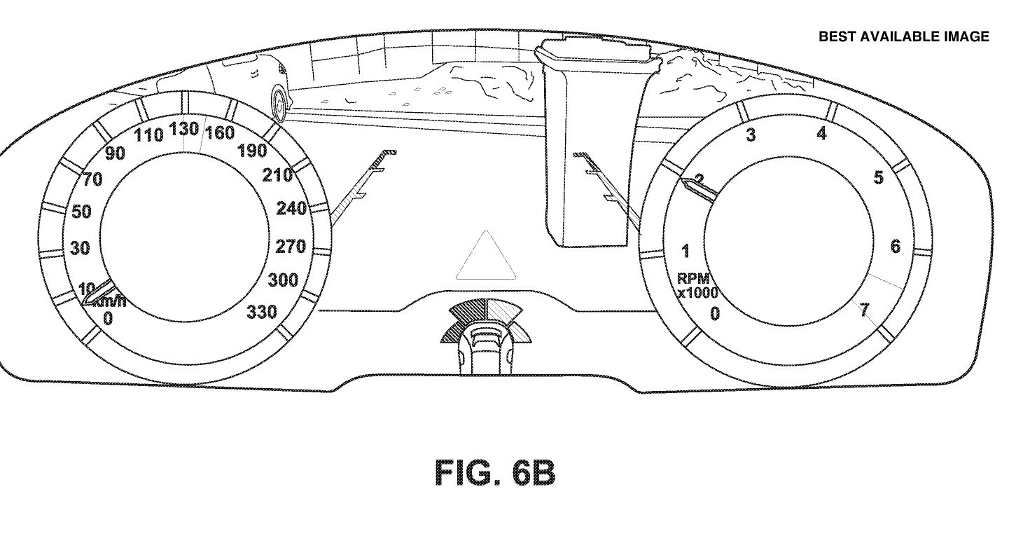

FIGS. 6A and 6B illustrate content that is displayed on a front screen and a back screen according to an embodiment of the present disclosure. FIGS. 6A and 6B correspond to content simultaneously displayed on different display screens in FIG. 5B. FIG. 6A illustrates content that is displayed on the front screen and FIG. 6B illustrates content that is displayed on the back screen.

As shown in FIG. 6A, portions of the tachometer, portions of the speedometer, and the alerts are displayed on a front screen. Other portions of the tachometer, other portions of the speedometer, and live video of the images captured by the camera are displayed on a back screen as shown in FIG. 6B.

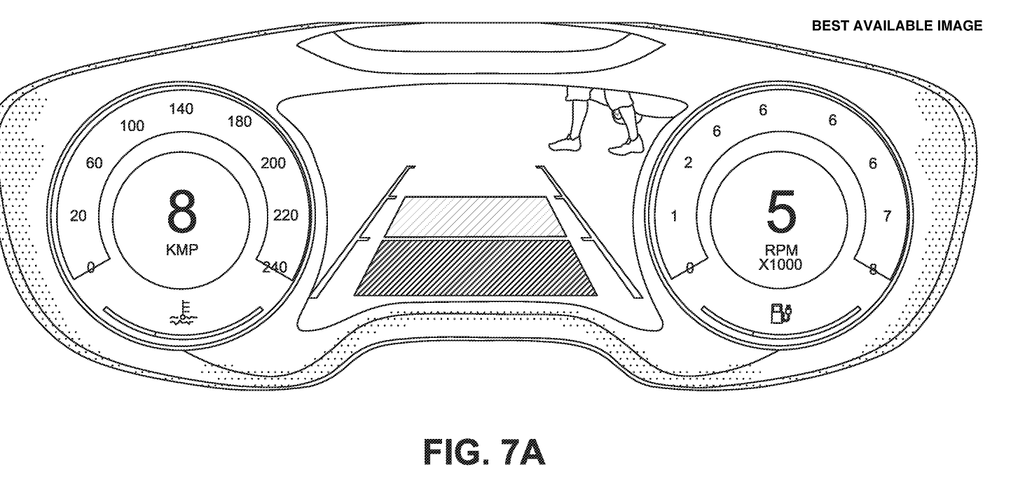

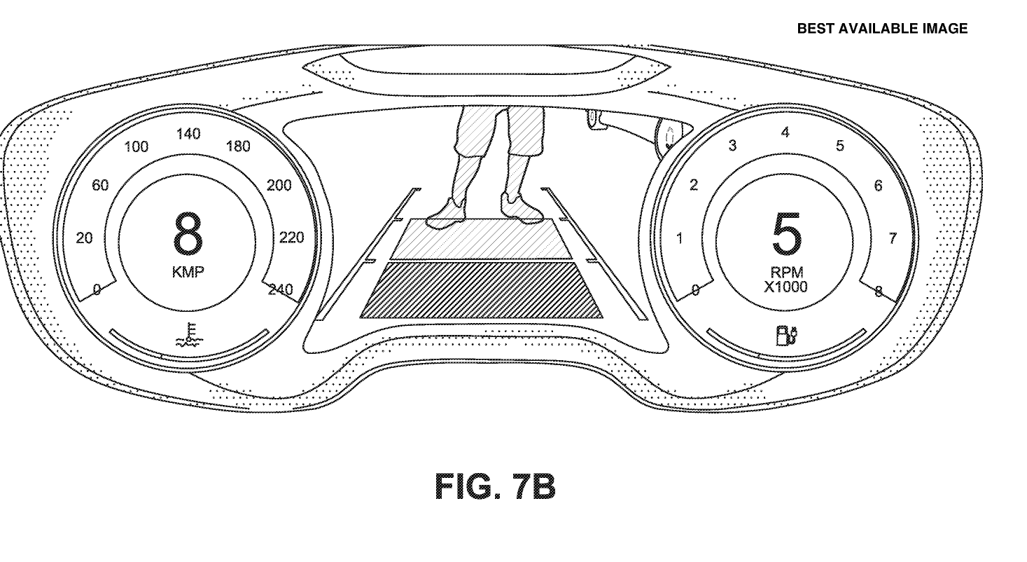

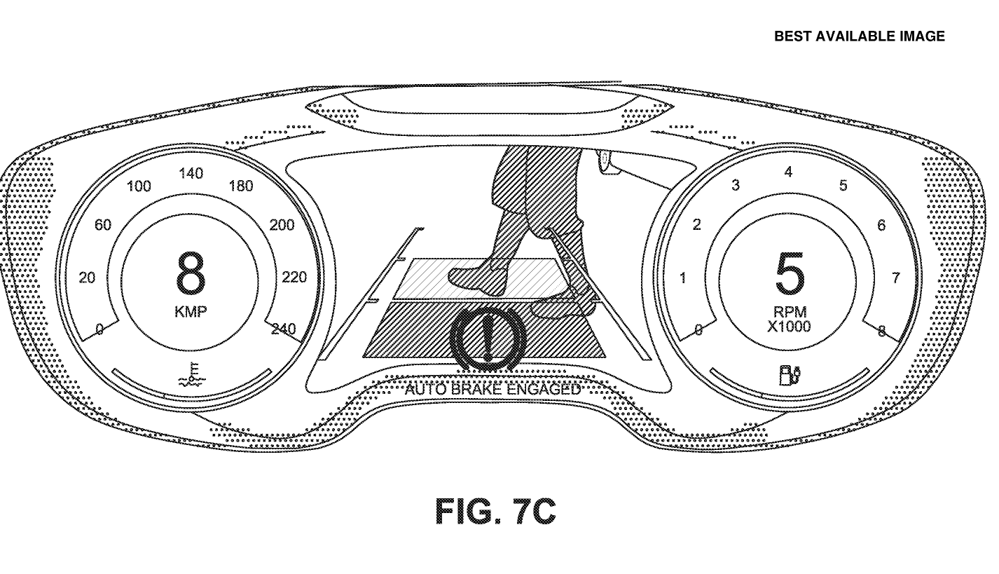

FIGS. 7A-7C illustrate displaying depth based alerts on an instrument panel including an MLD system according to another embodiment of the present disclosure. In FIG. 7A, the vehicle is in a reverse sequence. During the reverse sequence, an image of the space behind the vehicle is captured by a camera and displayed on a back screen of the MLD system. As shown in FIG. 7A, an object (i.e., a person) is captured in the image displayed on the back screen. Because the object is not in the estimated path of the vehicle, no alert is shown.

The estimated path of the vehicle may be shown in the image and/or divided into different regions based on the distance the region is to the vehicle. As shown in FIGS. 7A-7C, the estimated path is shown with parallel lines and the regions are divided by marks on the lines. The regions may be marked with different shading patterns and/or colors. The type of alert (e.g., color, size, and/or position of the alert) that is displayed may depend on in which region the object is detected.

In FIG. 7B, the object that is in the estimated path of the vehicle is detected. The outline of the object may be generated and displayed as an alert on a front screen of the MLD system. The outline of the object may be displayed in an overlapping manner (as viewed by the occupant) over the image including the object. The outline may be displayed in a predefined color (e.g., orange or yellow color) to warn the occupant that an object is within the path of the vehicle. The alert shown in FIG. 7B, is within a second region of the estimated path.

FIG. 7C illustrates an object that is in the estimated path of the vehicle and is a predetermined distance away from the vehicle (e.g., in a first region of the estimated path of the vehicle). As shown in FIG. 7C, the outline of the object may be generated and displayed as an alert on a front screen of the MLD system. The outline of the object may be displayed in an overlapping manner (as viewed by the occupant) over the image including the object. The outline may be displayed in a predefined color (e.g., red color) to warn the occupant that an object is in the path of the vehicle and a predetermined distance from the vehicle. The alert shown in FIG. 7B, is within a first region of the estimated path that is closest to the vehicle.

When the object is a predetermined distance away from the vehicle, additional alerts may be displayed on one or more screens. In FIG. 7C, the additional alerts include a symbol with a warning, text indicating that auto brake is engaged, and a warning light is displayed around at least a portion of the perimeter of the panel. The additional warnings may be displayed on a front screen. When an object is detected and is within a predetermined distance to the vehicle that is dangerous, the vehicle may be controlled to slow down and/or stop.

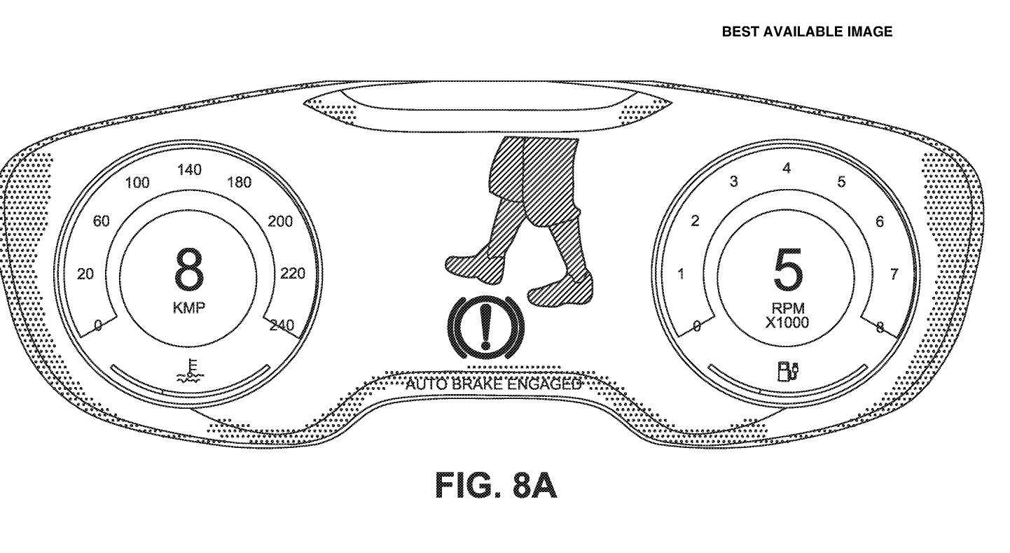

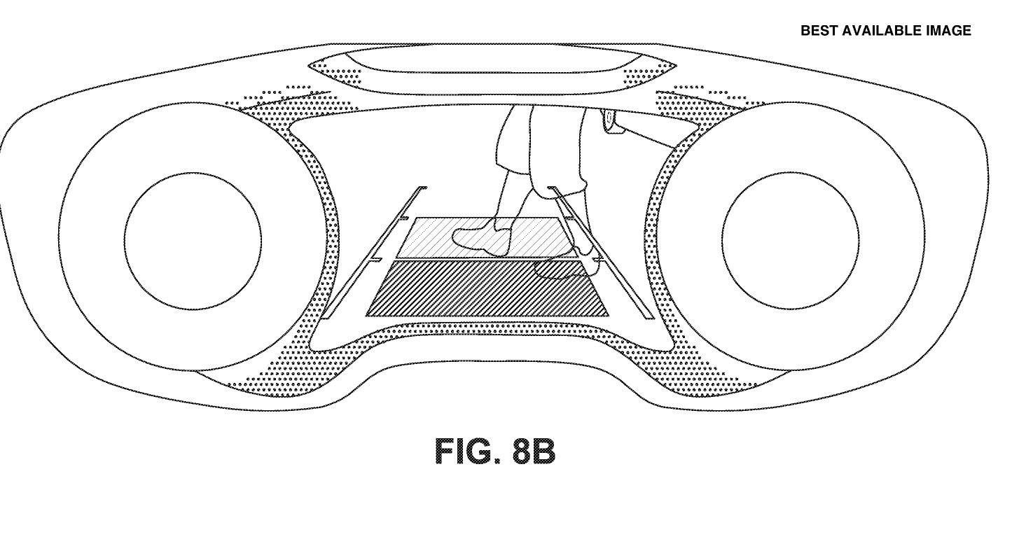

FIGS. 8A and 8B illustrate content that is displayed on a front screen and a back screen according to an embodiment of the present disclosure. FIGS. 8A and 8B correspond to content simultaneously displayed on different screens in FIG. 7C. FIG. 8A illustrates content that is displayed on the front screen and FIG. 8B illustrates content that is displayed on the back screen. As shown in FIG. 8A, portions of the tachometer, portions of the speedometer, and the alerts are displayed on a front screen. Other portions of the tachometer, other portions of the speedometer, and live video of the images captured by the camera are displayed on a back screen as shown in FIG. 8B.

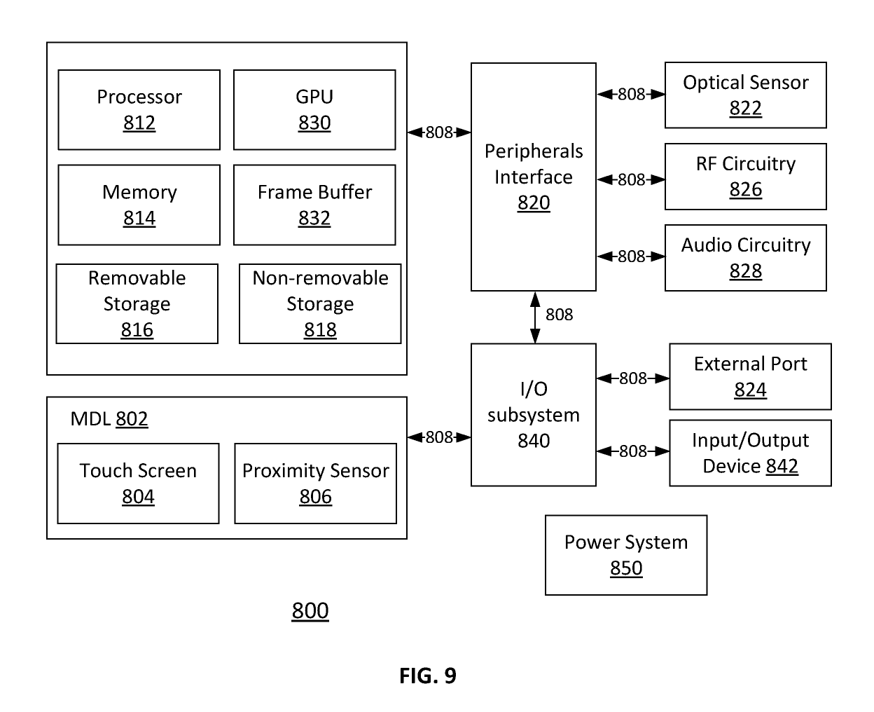

FIG. 9 illustrates an exemplary system 800 upon which embodiments of the present disclosure(s) may be implemented. The system 800 may be a portable electronic device that is commonly housed, but is not so limited. The system 800 may include a multi-layer display 802 including a plurality of overlapping displays. The multi-layer system may include a touch screen 804 and/or a proximity detector 806. The various components in the system 800 may be coupled to each other and/or to a processing system by one or more communication buses or signal lines 808.

The multi-layer display 802 may be coupled to a processing system including one or more processors 812 and memory 814. The processor 812 may comprise a central processing unit (CPU) or other type of processor. Depending on the configuration and/or type of computer system environment, the memory 814 may comprise volatile memory (e.g., RAM), non-volatile memory (e.g., ROM, flash memory, etc.), or some combination of the two. Additionally, memory 814 may be removable, non-removable, etc.

In other embodiments, the processing system may comprise additional storage (e.g., removable storage 816, non-removable storage 818, etc.). Removable storage 816 and/or non-removable storage 818 may comprise volatile memory, non-volatile memory, or any combination thereof. Additionally, removable storage 816 and/or non-removable storage 818 may comprise CD-ROM, digital versatile disks (DVD) or other optical storage, magnetic cassettes, magnetic tape, magnetic disk storage or other magnetic storage devices, or any other medium which can be used to store information for access by processing system.

As illustrated in FIG. 9, the processing system may communicate with other systems, components, or devices via peripherals interface 820. Peripherals interface 820 may communicate with an optical sensor 822, external port 824, RC circuitry 826, audio circuity 828 and/or other devices (e.g., proximity sensors, range sensors, laser sensors). The optical sensor 882 may be a CMOs or CCD image sensor. The RC circuity 826 may be coupled to an antenna and allow communication with other devices, computers and/or servers using wireless and/or wired networks. The system 800 may support a variety of communications protocols, including code division multiple access (CDMA), Global System for Mobile Communications (GSM), Enhanced Data GSM Environment (EDGE), Wi-Fi (such as IEEE 802.11a, IEEE 802.11b, IEEE 802.11g and/or IEEE 802.11n), BLUETOOTH (BLUETOOTH is a registered trademark of Bluetooth Sig, Inc.), Wi-MAX, a protocol for email, instant messaging, and/or a short message service (SMS), or any other suitable communication protocol, including communication protocols not yet developed as of the filing date of this document. In an exemplary embodiment, the system 800 may be, at least in part, a mobile phone (e.g., a cellular telephone) or a tablet.

A graphics processor 830 may perform graphics/image processing operations on data stored in a frame buffer 832 or another memory of the processing system. Data stored in frame buffer 832 may be accessed, processed, and/or modified by components (e.g., graphics processor 830, processor 712, etc.) of the processing system and/or components of other systems/devices. Additionally, the data may be accessed (e.g., by graphics processor 830) and displayed on an output device coupled to the processing system. Accordingly, memory 814, removable 816, non-removable storage 818, frame buffer 832, or a combination thereof, may comprise instructions that when executed on a processor (e.g., 812, 830, etc.) implement a method of processing data (e.g., stored in frame buffer 832) for improved display quality on a display.

The memory 814 may include one or more applications. Examples of applications that may be stored in memory 814 include, navigation applications, telephone applications, email applications, text messaging or instant messaging applications, memo pad applications, address books or contact lists, calendars, picture taking and management applications, and music playing and management applications. The applications may include a web browser for rendering pages written in the Hypertext Markup Language (HTML), Wireless Markup Language (WML), or other languages suitable for composing webpages or other online content. The applications may include a program for browsing files stored in memory.

The memory 814 may include a contact point module (or a set of instructions), a closest link module (or a set of instructions), and a link information module (or a set of instructions). The contact point module may determine the centroid or some other reference point in a contact area formed by contact on the touch screen. The closest link module may determine a link that satisfies one or more predefined criteria with respect to a point in a contact area as determined by the contact point module. The link information module may retrieve and display information associated with selected content.

Each of the above identified modules and applications may correspond to a set of instructions for performing one or more functions described above. These modules (i.e., sets of instructions) need not be implemented as separate software programs, procedures or modules. The various modules and sub-modules may be rearranged and/or combined. Memory 814 may include additional modules and/or sub-modules, or fewer modules and/or sub-modules. Memory 814, therefore, may include a subset or a superset of the above identified modules and/or sub-modules. Various functions of the system may be implemented in hardware and/or in software, including in one or more signal processing and/or application specific integrated circuits.

Memory 814 may store an operating system, such as Darwin, RTXC, LINUX, UNIX, OS X, WINDOWS, or an embedded operating system such as VxWorks. The operating system may include procedures (or sets of instructions) for handling basic system services and for performing hardware dependent tasks. Memory 814 may also store communication procedures (or sets of instructions) in a communication module. The communication procedures may be used for communicating with one or more additional devices, one or more computers and/or one or more servers. The memory 814 may include a display module (or a set of instructions), a contact/motion module (or a set of instructions) to determine one or more points of contact and/or their movement, and a graphics module (or a set of instructions). The graphics module may support widgets, that is, modules or applications with embedded graphics. The widgets may be implemented using JavaScript, HTML, Adobe Flash, or other suitable computer program languages and technologies.

An I/O subsystem 840 may include a touch screen controller, a proximity controller and/or other input/output controller(s). The touch-screen controller may be coupled to a touch-sensitive screen or touch sensitive display system. The touch screen and touch screen controller may detect contact and any movement or break thereof using any of a plurality of touch sensitivity technologies now known or later developed, including but not limited to capacitive, resistive, infrared, and surface acoustic wave technologies, as well as other proximity sensor arrays or other elements for determining one or more points of contact with the touch-sensitive screen. A touch-sensitive display in some embodiments of the display system may be analogous to the multi-touch sensitive screens.

The other input/output controller(s) may be coupled to other input/control devices 842, such as one or more buttons. In some alternative embodiments, input controller(s) may be coupled to any (or none) of the following: a keyboard, infrared port, USB port, and/or a pointer device such as a mouse. The one or more buttons (not shown) may include an up/down button for volume control of the speaker and/or the microphone. The one or more buttons (not shown) may include a push button. The user may be able to customize a functionality of one or more of the buttons. The touch screen may be used to implement virtual or soft buttons and/or one or more keyboards.

In some embodiments, the system 800 may include circuitry for supporting a location determining capability, such as that provided by the Global Positioning System (GPS). The system 800 may include a power system 850 for powering the various components. The power system 850 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices. The system 800 may also include one or more external ports 824 for connecting the system 800 to other devices.

Portions of the present invention may be comprised of computer-readable and computer-executable instructions that reside, for example, in a processing system and which may be used as a part of a general purpose computer network (not shown). It is appreciated that processing system is merely exemplary. As such, the embodiment in this application can operate within a number of different systems including, but not limited to, general-purpose computer systems, embedded computer systems, laptop computer systems, hand-held computer systems, portable computer systems, stand-alone computer systems, game consoles, gaming systems or machines (e.g., found in a casino or other gaming establishment), or online gaming systems.

Embodiments of the subject matter and the functional operations described herein can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a tangible non-transitory storage medium for execution by, or to control the operation of, data processing apparatus (i.e., one or more computer programs). The computer storage medium can be one or more of: a machine-readable storage device, a machine-readable storage substrate, a random or serial access memory device, and combinations thereof.

1. An instrument panel comprising;
a multi-layer display including a first screen and a second screen arranged in a substantially parallel manner, the first screen and the second screen including an array of pixels and the second screen overlapping the first screen;
a light configured to provide light to the first screen and the second screen of the multi-layer display; and
a processing system comprising at least one processor and memory, the processing system configured to:
receive data from at least one camera;
based on the receive data from the at least one camera, display an image on the first screen;
determine if an object in the image satisfies a predetermined condition; and
upon determining that the object in the image satisfies the predetermined condition, display on the second screen an alert at least partially overlapping the object in the image displayed on the first screen.

2. The instrument panel of claim 1, wherein determining if the object in the image satisfies the predetermined condition includes determining that the object is in a predetermined portion of the image corresponding to path of a vehicle including the instrument panel.

3. The instrument panel of claim 1, wherein determining if the object in the image satisfies the predetermined condition includes determining that the object is within a threshold distance from a vehicle including the instrument panel.

4. The instrument panel of claim 1, wherein determining if the object in the image satisfies the predetermined condition includes determining that the object is within a path of a vehicle including the instrument panel and within a threshold distance from the vehicle.

5. The instrument panel of claim 1, wherein the processing system is further configured to: receive data from a range sensor; and determine, based on the received data from the range sensor, whether the object in the image is within a threshold distance from the range sensor, and wherein the predetermined condition is that the object in the image is within the threshold distance from the range sensor.

6. The instrument panel of claim 1, wherein the alert is a feature with a shape corresponding to a shape of the object in the image.

7. The instrument panel of claim 6, wherein the alert is displayed with a first color when the object is determined to be positioned within a first distance from a vehicle including the instrument panel, and is displayed with a second color when the object is determined to be positioned within a second distance from the vehicle that is smaller than the first distance.

8. A multi-layer display system comprising:
a first display panel and second display panel arranged in a substantially parallel manner, the second display panel overlapping the first display panel;
a backlight configured to provide light to the first display panel and the second display panel of the multi-layer display system; and
a processing system comprising at least one processor and memory, the processing system configured to:
receive image data from at least one camera;
based on the received data from the at least one camera, display images on the first display panel;
determine if an object in the images is within a moving path of a vehicle and/or is with a predetermined distance from the vehicle; and
upon determining that the object is within the moving path of the vehicle and/or is with the predetermined distance from the vehicle, display, on the second display panel, an alert corresponding to the object in the images.

9. The multi-layer display system of claim 8, wherein the alert comprises a shape corresponding to a shape of the object in the images and the alert is displayed in an overlapping manner with the object in the images.

10. The multi-layer display system of claim 9, wherein at least a portion of the alert is displayed with a partial opacity.

11. The multi-layer display system of claim 8, wherein the alert is displayed with a first color when the object is determined to be positioned within a first distance from the vehicle and a second color when the object is determined to be positioned within a second distance from the vehicle that is smaller than the first distance.

12. The multi-layer display system of claim 8, wherein the object in the image and the alert have the same shape and size.

13. The multi-layer display system of claim 8, wherein the alert is displayed on the second display panel at predetermined intervals while the object is within the moving path of the vehicle and/or is with the predetermined distance from the vehicle.

14. The multi-layer display system of claim 8, wherein the images are displayed on the first display panel in response to processing system receiving a signal indicating that the vehicle is in a reverse driving mode.

15. A vehicle display system comprising:
a sensor disposed on a vehicle;
a camera configured to capture images of an area behind the vehicle;
a multi-layer display including a back display panel and a front display panel arranged in a substantially parallel manner, each display panel including an array of pixels;
a backlight configured to provide light to the front and back display panels; and
a processing system comprising at least one processor and memory, the processing system configured to:
receive sensor data from the sensor;
receive image data from the camera;
in response receiving a signal indicating that the vehicle is in a reverse driving mode, display, on the back display panel, images based on the received image data;
based on the received sensor data and/or the received image data, determine whether an object is present in an estimated path of the vehicle; and
upon determining that the object is present in the estimated path of the vehicle and the object satisfying a predetermined condition, display an alert on the front display panel, the alert having a shape and size corresponding to the object.

16. The vehicle display system of claim 15, wherein the object is included in the images displayed on the back display panel, and the alert is displayed with partial opacity on the front display panel and overlapping the object in the images.

17. The vehicle display system of claim 15, wherein the predetermined condition is the object being within an predetermine distance from the vehicle, the alert is displayed with a first color when the object is determined to be positioned within a first distance from the vehicle, and the alert is displayed with a second color when the object is determined to be positioned within a second distance from the vehicle.

18. The vehicle display system of claim 17, wherein the position of the object from the vehicle is determined based on the received sensor data.

19. A method for displaying content on a multi-layer display system including at least first display panel and second display panel arranged in a substantially parallel and overlapping manner, the method comprising:
receiving image data from at least one camera disposed on a vehicle;
based on the received data from the at least one camera, displaying images on the first display panel;
determining if an object in the images is within a moving path of a vehicle and is with a predetermined distance from the vehicle; and
upon determining that the object is within the moving path of the vehicle and is with the predetermined distance from the vehicle, displaying, on the second display panel, an alert corresponding to the object in the images.

20. The method of claim 19, wherein the alert is displayed with a first color when the object is determined to be positioned within a first distance from the vehicle and a second color when the object is determined to be positioned within a second distance from the vehicle that is smaller than the first distance.
